(19) United States
(12) Patent Application Publication
(10) Pub. No.: US 2005/0222897 A1
(43) Pub. Date: Oct. 6, 2005

(54) Method and system for improving at least one of a business process, product and service

(76) Inventors: Johann Walter, Erlangen (DE); Hans Meth, Seukendorf (DE); Rudi Schwarz, Erlangen (DE); Juergen Webs, Adelsdorf (DE)

Correspondence Address: HARNESS, DICKEY & PIERCE, P.L.C., P.O.BOX 8910, RESTON, VA, 20195, US

(21) Appl. No.: 11/032,031

(22) Filed: Jan. 11, 2005

Related U.S. Application Data
(60) Provisional application No. 60/558,307, filed on Apr. 1, 2004.

(51) Int. Cl. G06F 17/60

(52) U.S. Cl. 705/10

(57) ABSTRACT

A method is for improving at least one of a business process, product and service. The method may include accessing data relating to business objects of the at least one of a business process, product and service from a plurality of different databases. Thereafter, the accessed data may be translated and correlated for subsequent use in improving the at least one of a business process, product and service.

The present application hereby claims priority under 35 U.S.C. §119 on U.S. provisional patent application No. 60/558,307 filed Apr. 1, 2004, the entire contents of which are hereby incorporated herein by reference.

### FIELD OF THE INVENTION

The present invention generally relates to at least one of a method and system for improving at least one of a business process, product and service, including but not limited to the competences of employees.

### BACKGROUND OF THE INVENTION

All enterprises, including business, public offices, hospitals, etc. have to fix the results of their activities in documents. This can include, but is not limited to for example, customers addresses, orders, profiles of employees, etc. Functional organization and functional kinds of working tend to necessarily result in functionally oriented forms, templates, descriptions, representations, etc. When the results of one function go to another function, the result of the former function is often transformed into the format of the function, e.g. in many cases a paper format is transformed into an IT (information technology) format.

The functional orientation of enterprises, business, public offices, hospitals, etc. tends to lead to “island” solutions. The processes and approaches within a function are optimized, wherein the improvement is often based on Information Technology (IT) applications. For example, the radiological department of a hospital uses electronic patient recording, digital subscription, digital imaging of x-ray examination and digital archiving of the pictures, but the digital images cannot be used any further since in the ward and operation department, paper is still used for recording patient's status, medication, etc. Thus, while a solution to a problem may yield an improvement in the radiological department of a hospital, the improvement cannot be globally applied throughout the hospital and is thus an “island” solution.

The disadvantage of island solutions is the missing overall applicability for improving a business process, product, and/or service, etc. Mostly it is unclear as to what is determining the business outcomes, which are the really important business areas, and which are the necessary objects of the business. In administration, especially in accounting, common solutions in enterprises exist to cover the legal requirements of governmental taxes. In this case, a very important area of an enterprise may be handled. At the end, accounting is the only global support for the real business processes like sales, order processing or new product development.

Improvements in the business area largely depend on information obtained during the course of business. These data can then be used to analyze the business transaction, to compare the performance to that of other businesses, and to check the effectiveness of measures for improving the business. This type of business information is primarily collected and processed in central controlling departments.

The information is collected based on very different criteria and is derived from data in different IT systems using different software applications. The IT systems are often set up to optimally support day-to-day business operations. As a result, an incredible number of different IT applications are generated which each meet a purpose. However, they are rarely compatible and, as such, do not support and promote overall coordinated improvements in business.

In many cases, the IT application is selected based on functional considerations, e.g. an application to support financial management; an application to support logistics, order processing, acquisition; design and construction in product development; etc. The IT applications typically represent local optimums.

With IT applications such as SAP or Siebel for example, large amounts of data accumulate, which are then allocated to objects such as orders, products, clients, etc. Depending on the degree of processing, e.g. of an order, the object can take on different states. In many cases, the IT applications are linked to a database from which monthly reports, for example, are generated.

If contents of an IT application are combined, this is referred to as a data warehouse. From these data, reports, and trends can be generated. However, the data must be compatible to be useful.

The processes oftentimes are purely descriptive processes, using aids such as text editors, while the contents are frequently visualized with web technology. Complex process chains, for example, can be described with IT applications such as ARIS, which permit event-controlled sequence chains. Oftentimes there is a link between the process or the process description and the IT application through reference to the corresponding application, e.g. a document management system in the product development. However, the data from different IT programs are often incompatible.

### SUMMARY OF THE INVENTION

Thus, a need exists for improving overall aspects of a business process, product, and/or service in a more global manner.

An object of an embodiment of the present invention is to provide a method of improving at least one of a business process, product and service. The method includes accessing data relating to business objects of the at least one of a business process, product and service from a plurality of different databases and translating the accessed data. Thereafter, the translated data is correlated for subsequent use in improving the at least one of a business process, product and service.

An object of another embodiment of the present invention is to provide a method of improving at least one of a business process, product and service. The method includes accessing data relating to the at least one of a business process, product and service from a plurality of different databases, wherein the data are accessed from databases supported by a plurality of different IT applications. Thereafter, the accessed data is translated into compatible data. Finally, the translated compatible data is correlated, wherein the correlations are used to improve the at least one of a business process, product and service.

In addition, an object of yet another embodiment of the present invention can be achieved by embodying any of the aforementioned methods in the form of a system or device; or in the form of a program. The program may be stored on a computer readable media and may be adapted to perform any one of the aforementioned methods when run on a computer device (a device including a processor). Thus, the storage medium or computer readable medium may be adapted to store information and is adapted to interact with a data processing facility or computer device to perform the method of any of the above mentioned embodiments.

An object of yet another embodiment of the present application is to provide a system for improving at least one of a business process, product and service. The system may include a process house, adapted to store data in data bases relating to objects of a business, wherein the data are stored in databases supported by a plurality of different IT applications; a transaction layer, adapted to access data relating to the at least one of a business process, product and service from a plurality of different databases, and adapted to translate the accessed data into compatible data; and an information house, adapted to correlate the translated compatible data, wherein the correlations are used to improve the at least one of a business process, product and service.

For a full understanding of the nature and advantages of the various aspects of the invention, reference should be made to the detailed description of exemplary embodiments taken in conjunction with the accompany drawings. The detailed description provides only exemplary embodiments of the invention and thus, the claims of the present invention should not be limited as such.

### BRIEF DESCRIPTION OF THE DRAWINGS

Further features, advantages and possible applications of the present invention emerge from the following description of preferred exemplary embodiments of the invention, which are depicted in the drawings presented below, and in which:

FIG. 1 shows an example of the overall process flow of an embodiment of the present application;

FIG. 2 shows an example of business objects and relationships to IT applications;

FIG. 3 shows an exemplary aspect of the interaction between the transaction layer, the process house, the IT applications and the data warehouse;

FIG. 4 shows an example of the usage of three modules A, B, C and their linkage and their representation in IT-tools;

FIG. 5 shows an example of how the structure of business objects may look;

FIG. 6 shows an example of how the process house is linked to objects in a process and the structure of the business objects; and

FIG. 7 shows an example of how the output of the processes is linked to the IT applications and how the transactions layer transforms the data of the IT applications into the data warehouse, which is used by the information house.

### DETAILED DESCRIPTION OF THE EXEMPLARY EMBODIMENTS

In one embodiment, the present invention is directed to a method of improving at least one of a business process, product and service. The method may include accessing data relating to business objects of the at least one of a business process, product and service from a plurality of different databases. Thereafter, the accessed data may be translated and correlated for subsequent use in improving the at least one of a business process, product and service.

The translating may be achieved in a transaction layer. The transaction layer may include rules for translating the data, obtained from different databases, into compatible data for correlation. At least a portion of the data stored in at least one database may be incompatible with at least a portion of the data stored in at least one other database. As such, the translating may include translating at least a portion of the data stored in each of the at least one and at least one other database into data compatible for correlation.

Further, at least some of the plurality of different databases are supported by different IT applications. At least some of the data stored in databases supported by different IT applications may further be incompatible with each other. As such, the translating may include translating at least a portion of the data stored in each of the at least one and at least one other database into data compatible for correlation.

In another embodiment, the present invention is directed to a method of improving at least one of a business process, product and service. The method may include accessing data relating to the at least one of a business process, product and service from a plurality of different databases, wherein the data may be accessed from databases supported by a plurality of different IT applications. Thereafter, the accessed data may then be translated into compatible data. Further, the translated compatible data may be correlated, wherein the correlations may be used to improve the at least one of a business process, product and service.

In each of the embodiments, at least one report may be generated from the correlated data. The generated report may then be sent to a process house for use in improving the at least one of a business process, product and service. Further, the process house may use the generated at least one report to improve upon the handling of the business objects and thereby improve the at least one of a business process, product and service.

In addition, or alternatively, the process house may store at least one of management, operating and support processes for the at least one of a business process, product and service, and may use the generated at least one report to improve upon the handling of at least one of the management, operating and support processes to thereby improve the at least one of the business process, product and service. Thus, the generated report may be sent to a process house for use in improving the at least one of a business process, product and service.

The above-described embodiments of the present invention may be based on combining individual models, modules, and methods for a process, product and service, and for supporting processes with IT applications and data warehouses in an enhanced or even optimum new type of methodology. Thus, although most of the examples discuss business processes, they are also applicable to business products, services, etc., including but not limited to competences of employees.

The business objects follow a lifecycle process. For example a product or service idea rises, the idea is verified, cleared and put into product or service requirements. It is then developed, launched in the market, observed and serviced there. From there it is improved and upgraded and eventually removed from the market. It may then be disposed of, or it may be refurbished for a second lifecycle. In any event, the old product is reviewed and people learn from it before launching a new product or next-generation product or service in a second lifecycle. The same is also true for employees who are hired, developed according to their task and eventually retired at the end of their profession, wherein their competence and attributes can be examined for the next lifecycle generation.

Therefore these business objects follow the basic principle of processes: repetition and continuous improvement. Thus, the data collected on processes, products and services, competencies of employees etc. in different IT applications may be used for improving process performance, product and service quality, skills of employees, etc in this lifecycle model.

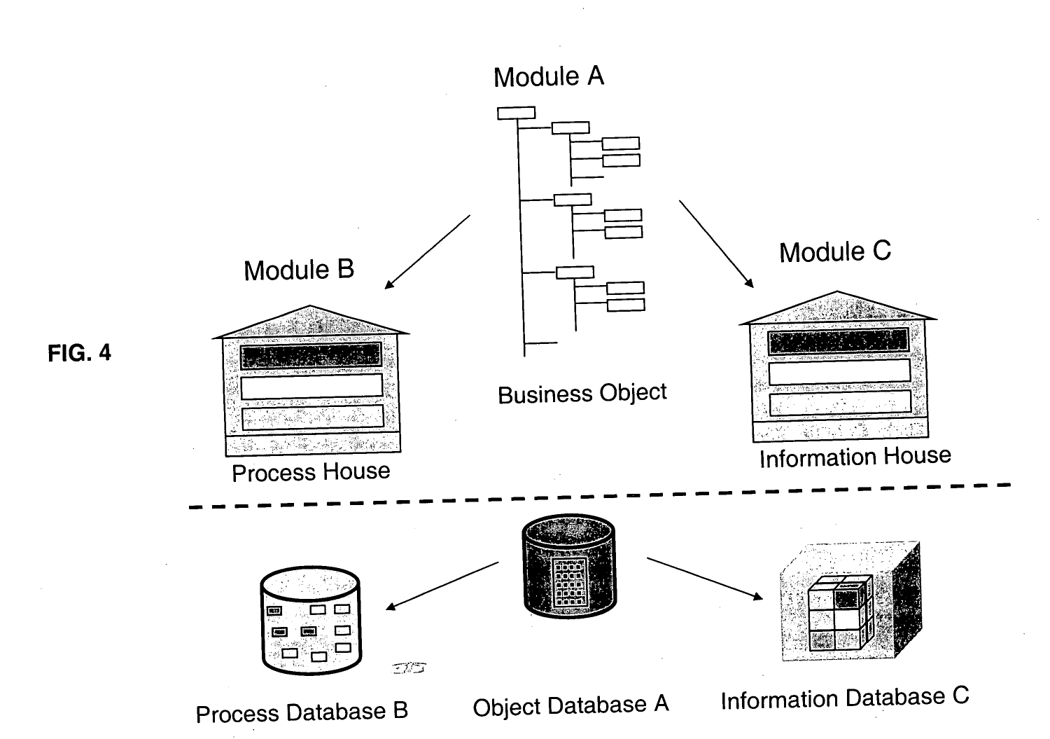

As to structure of the system, a system may be created, as can a universally usable new process and information model. The system may be software driven and may include at least one computing device and memory, interacting with other existing IT applications and potentially using existing system equipment. The databases may be supported by a plurality of different IT applications. The system may include business objects, a process house and an information house and may be directly supported by IT applications (see FIG. 4).

The business objects may be stored in a database to provide worldwide access to these business objects. The process descriptions may be stored in an IT application, which allows consistent depiction of processes. Further, the information house may be based on a common data warehouse, which is fed via the transaction layer by the different IT applications supporting the processes.

In one embodiment, the system can include a device for accessing data relating to the at least one of a business process, product and service from a plurality of different databases, wherein the data are accessed from databases (for example, supported by a plurality of different IT applications); a device for translating the accessed data into compatible data; and a device for correlating the translated compatible data, wherein the correlations are used to improve the at least one of a business process, product and service.

This system and method permits making a lasting improvement in business practices based on process-oriented data and information as a result of the new and purposely result-oriented structure of this business model. The methodology of this business model can be applied to any type of enterprise, business unit, or organization in the public and non-public domain, regardless of which purpose an organizational unit fulfils, since each output oriented unit records data via processes or process sequences and because this is done in conjunction with IT application support.

The process and information model of one embodiment of the present invention can aid in obtaining the long-term success of the business or organization since this model is based on the economic ‘principle’ of continuous improvement, which can be applied to products and services, as well as competences, for example for employees, etc. The elements of this model can include the processes outlined above and the data obtained through these processes. Further, it can include such data which, when processed into information, not only reflect the effectiveness of process improvements that have been initiated, but also can supply the basis for the analysis of additional process and business improvements. In addition, the process-oriented collecting of data and processing of data allows a comparison to existing business goals and to the results of other businesses or organizations, within the meaning of benchmarking and best practice sharing.

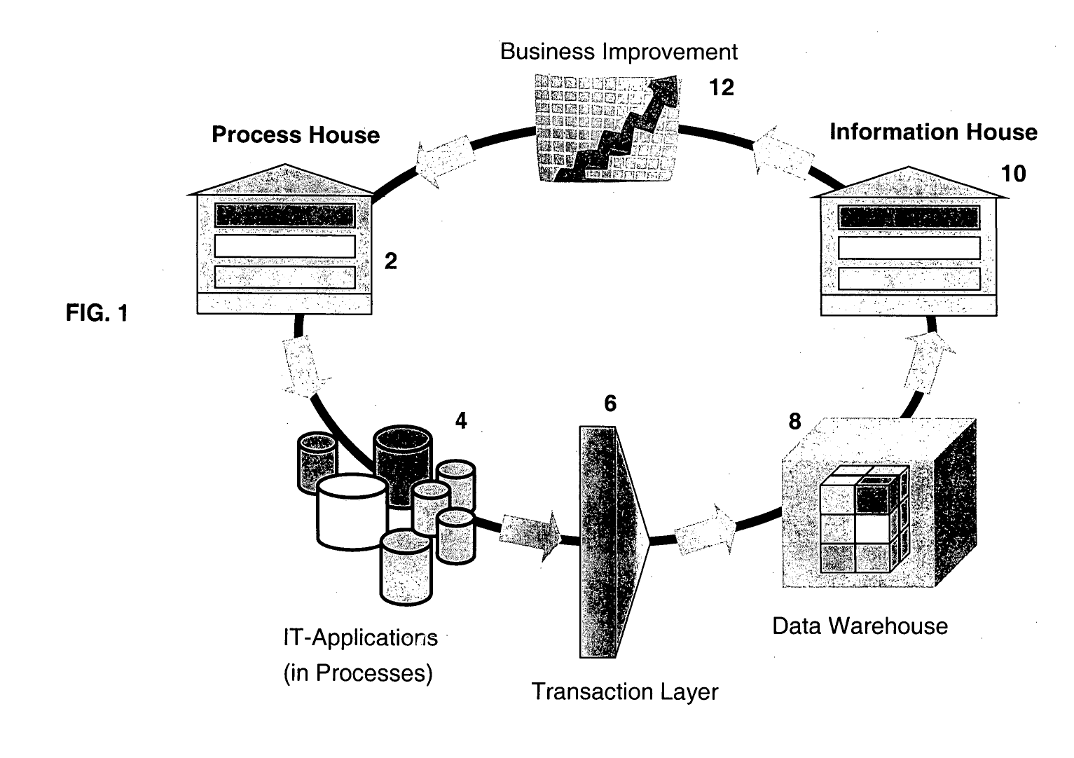

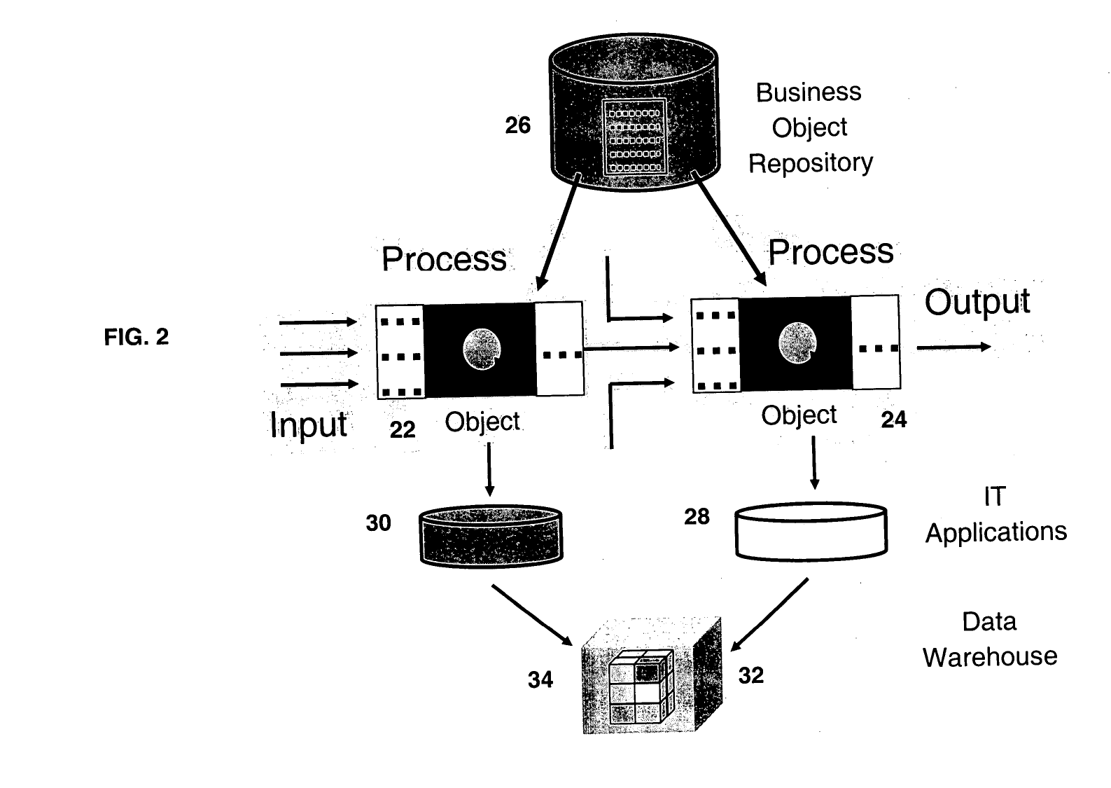

FIG. 1 shows an illustration of the methodology model. The model starts with a complete description of the business processes, the so-called process house 2. Each of the process input and output variables contains at least one so-called business object. These business objects form the basis for the objects in the IT applications that serve to support the processes. A business object is visually shown in FIG. 2 for illustrative purposes.

A business object can be unique for a business or common among many businesses. As shown in FIG. 2, two business objects 22 and 24 are illustrated. An object may be a customer, a delivery, product sale, etc. and/or anything that affects the business. Each object has an input and output, wherein an object input may be an output of another object and an object output may be input to another object. The objects may be stored in a repository 26, or in some other type of data warehouse.

The business objects are each supported by at least one IT application 28, 30. The IT applications may be stored in separate or the same data warehouse 32, 34, wherein one IT application may be SAP to support supply chain type business objects, another can be another IT platform/application for supporting human resources type business objects, another can be another IT platform/application for supporting quality management type business objects, etc. In other words, different business objects may be supported by different IT applications, which may generate incompatible data, depending on the tasks of functions like quality management, human resource management or logistic management.

Referring back to FIG. 1, from the IT applications 4 in FIG. 1, data may then be extracted and translated via a transaction layer 6 and collected in data warehouses 8 as (selected) business objects. The transaction layer 6 may be a virtual structure, derived from the input-output variables or business objects from the process house 2. The individual elements of the transaction layer include business object types, which permit the transformation or translation of a business object of the IT application to a business object in the data warehouse 8, and corresponding to the total process structure, the process house 2. Thus, the transaction layer 6 has the ability to translate potentially previously incompatible data into compatible data for storage into the data warehouse 8.

The transaction layer 6 may include rules for translating the data, obtained from different databases, into compatible data for correlation. Thus, at least a portion of the data stored in at least one database may be incompatible with at least a portion of the data stored in at least one other database, and the translating may include translating at least a portion of the data stored in each of the at least one and at least one other database into data compatible for correlation.

Accordingly, the data may be accessed, translated into compatible data and then stored prior to correlation. More specifically, the data may be stored in a data warehouse 8, and then correlated in an information house 10.

The information house 10, which represents a direct mirror image (in structure) of the process house 2, may be created via a further compressing or reducing of the business object. Consequently, a direct relationship between HOW the business is conducted (see process house) and WHAT the results of the processes are (see information house) may be created via the business objects. As such, at least one report may be generated from the correlated data, and/or the report may be sent to the process house 2 for use in improving the at least one of a business process, product and service 12. As such, a feedback type system and method, or complete loop as shown in FIG. 1, can be provided for improving at least one of a business process, product and service.

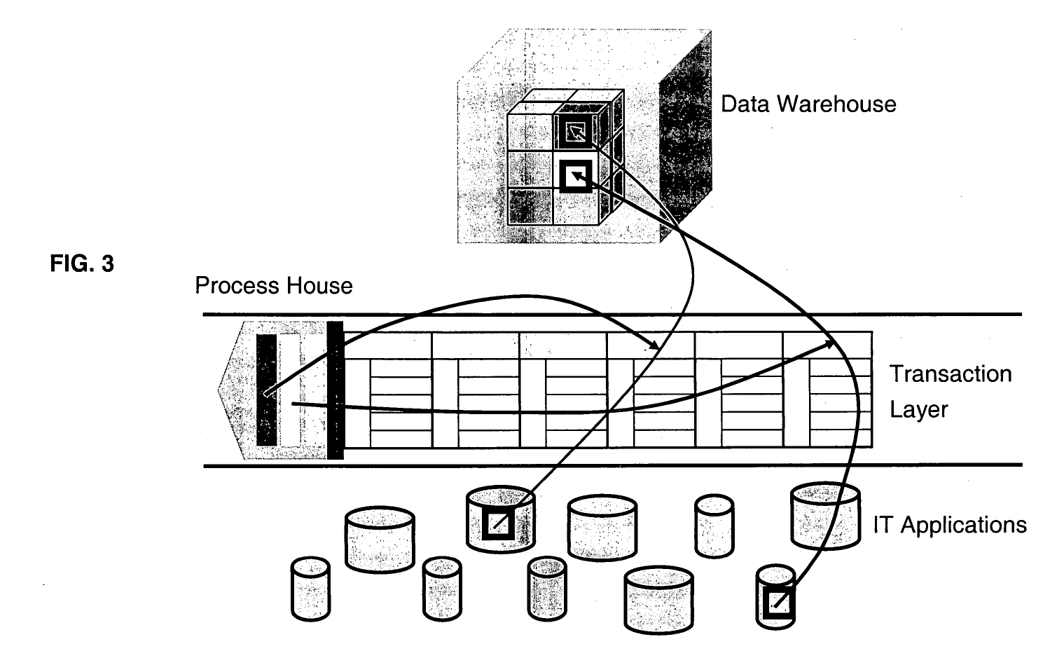

FIG. 3 illustrates the relationship between the IT applications 4, business objects, data and databases supported thereby; and the transaction layer 6 and its relationship with rules from the process house 2; and the storage of translated data in the data warehouse 8. The relationship is discussed in a non-limiting exemplary fashion as follows.

For example, a business object may be an order. Fulfilment of the order may work as follows. An order is received in an enterprise, checked, accepted, released, perhaps corrected, processed, manufactured, packed, sent, delivered, installed at customer's site, accepted by the customer, paid and finally closed.

Depending on the partners and functions of an enterprise involved in the order fulfilment process described above, a plurality of different IT applications 4 from different vendors may be used to support the specific tasks within the process chain. To improve the order process as a whole—from the customer to the customer—a consistent set of data should be obtained/derived and sent to/stored in the data warehouse 8 to eventually yield valid and useful information on the order process and the business objects, as well as to obtain the status of the objects during the processing.

As shown in FIGS. 1-3, a consistent set of data in the data warehouse 8 may be achieved by processing the data obtained from the different IT applications 4 within a transaction layer 6 by a set of rules directly related to the process house 2 via the business objects. In this way, data for a ‘client’, for example, stored in one IT application may be transformed into data for a ‘customer’, for example, which may be the defined business object out of the common business object repository 26 relevant to the process house 2 and the information house 10. Thus, the transaction layer 6 may be formed from rules based on the processes in the process house 2. As such, it represents the business objects and the status of business objects during the order process.

For example, a rule may be: obtain ‘contract’ from a certain IT application; obtain ‘order’ from another IT application; convert them to the business object ‘order’; fix the assigned date and measure the runtime between process step ‘order released’ and process step ‘order paid’ according to the process description in the process house 2. A report may then be generated in the information house 10, based on the data warehouse 8. By using the transaction layer 6, a report may thus be a consistent overview based on consistent data. For example, it may include statistics on runtimes in the order process over time, for classes of orders compared with data of other companies.

Thus, the system and method of one exemplary embodiment of the invention may include:
Process house 2: which may include, for example, a complete description of the business processes, including management and support processes, from which a set of rules related to the process house 2 may be derived and used in the transaction layer 6;
Business objects: which may include, for example, business-relevant variables with process-relevant information;
Business object type: which may include, for example, element(s) for describing business objects;
at least one IT application 4: which may include, for example, an optimum IT technical support of the respective business process;
Transaction layer 6: which may include, for example, an IT technical solution for extracting and translating different data and data structures, using a set of rules related to the process house 2, from different IT applications 4 into compatible data of a data warehouse 8 on the basis of business object types;
Data warehouse 8: for collecting data in individual process-oriented data cubes on the basis of, preferably, one technical platform; and
Information house 10: directly mirror imaging the information to the business objects from the process house 2.

Business improvements may focus on individual business aspects, e.g. asset management or improvement in the product quality. For this, data may again and again be pulled from IT applications 4 or data warehouses 8 and processed accordingly. As a result of a total approach, the process and information model of the methodology of an embodiment of the present application may provide one or more of the following:
Permit a consistent monitoring of the business-relevant variables;
Reflect the trends in the course of business;
Provide a lasting record of the effectiveness of business improvements; and/or
Create new ways of improving business through correlating the most different variables.

The process and information model of the methodology of an embodiment of the present application may further have one or more of the following advantages:
It may connect the process world to the IT world;
It may reduce the multitude of IT data to business-relevant objects;
It may allow gathering consistent process and business-relevant information, despite the multitude of IT applications;
It may promote the process and business improvement in the operative units without detour via the controlling functions;
It may permit the high flexibility in the processes through adapted IT applications and still result in consistent business information; and/or
It may be efficient since only the business-relevant data need be recorded, stored, and filed.

Accordingly, a system may be created for improving at least one of a business process, product and service. The system may include a process house 2, adapted to store data in data bases relating to objects of a business, wherein the data are stored in databases supported by a plurality of different IT applications 4. The system may further include a transaction layer 6, adapted to access data relating to the at least one of a business process, product and service from a plurality of different databases, and adapted to translate the accessed data into compatible data (and potentially store in data warehouses 8). Finally, an information house 10 may be included, adapted to correlate the translated compatible data, wherein the correlations are used to improve the at least one of a business process, product and service.

An advantage of an embodiment of the invention may rest in the elegant connection of the most diverse IT applications 4 with a total process model up to a business information model. One key to this connection is the transaction layer 6, a virtual model of the business object, which is derived from the process house 2. Another advantage of an embodiment of the invention may be its applicability to any type of organization. A further advantage may be obtained in that the model of the transaction layer 6 can also be applied to other attributes of a process, e.g. to roles or methods or tools. An embodiment of the invention can therefore always be applied in cases where a consistent unit (data warehouse, organization, etc) is to be created from diverse data (IT applications, roles, etc.).

The following example will be discussed in terms of a business process. However, the embodiments of the application are also applicable to a business product, service, etc.

A business enterprise typically uses at least three modules. One module (A) contains all the business objects of an enterprise, like customer, product, offer, order, profile of an employee, etc. The second module (B) contains all the information how to deal with the objects of module A in the sense of processes, approaches, procedures. The third module (C) contains all the information on what has been done on the objects in the sense of results of the processes of module B.

Module B may include a comprehensive framework of all business processes, from management processes like strategic planning and controlling, via operation processes like customer relationship management, supply chain management and product lifecycle management, down to support processes like accounting, quality management, document management, human resource management etc. The business processes may include the activities of an enterprise, including but not limited to strategic planning and qualifying employees. A key of a business process is not so much the activity itself, but the result of the process, equivalent to output of a process, which is the input of the following process step.

The transition from one process to another is defined as an interface between processes. The inputs and outputs are the same as the business objects stacked and described in module A.

The interfaces often define a change in responsibility for process output. There exist interfaces within an enterprise or from enterprise to an other or to legal office dealing with tax or life insurance, for example.

Module C contains all the information about what happened with business objects (of module A) in the business processes (of module B). The business object ‘order’ comes into a company. The first process step in the business process ‘Supply Chain Management’ might be to accept the order. A next process step might be to clarify if all material is available to fulfil the order at the desired date. A last process step might be to check if the order is correctly paid. Thus, the business object ‘order’ takes different states in the business process ‘Supply Chain Management’.

All of these states characterize different outputs of the processes. The output may be correct or not the first time the objects goes through the process step. Seeing how many objects running through the process actually pass the process correctly and which do not, is very valuable information. This information can be used for analysis to correct and/or improve the process and also to see if an improvement activity ended up the desired way.

Currently, for collecting all the information regarding the output of processes, mostly IT applications are used like SAP ERP (enterprise resource planning) systems. These IT applications 4 store all the information on order processing, the identification of an order, the date and the result of an action.

To use the data for process improvement, it is necessary to summarize the results concerning different orders to determine a trend or deviations from one to the other. In this way, an indication of the performance of a process may be obtained. Normally, to analyze processes, the IT application itself, which supports the process like order processing, is normally not used. Instead, certain data are extracted into a data warehouse 8 for specific processing.

The simple case of analysis is a report, provided regularly or on demand. More advanced analyses include trends, especially if combined with goals and best-in-class comparisons. An advanced kind of analysis represents data mining.

In the case of data mining, results of different processes are correlated with each other and they are examined to determine which performance measures predominate as so-called leading indicators, i.e. the lagging indicators. For example sales figures may be compared with people satisfaction. Alternatively, or in addition thereto, customer loyalty may be correlated with the on-time delivery installation of orders.

In one embodiment of the present application, it has been discovered that with a consistent set of business objects (module A), which cover many and even all business issues; with processes dealing with the business objects in many or even all business processes from management operation to support (module B); and with the data on processed business objects, extracted out of IT applications 4 and stored into a data warehouse 8 for example (module C), not only can processes be improved, but the whole business can be improved. Thus, an embodiment of the present application involves such methodology. This can be done in a continuous, sustainable way, which is on-going for example. As such, the ups and downs of business performance, depending on more or less arbitrarily decisions, can be reduced and even avoided.

Thus, a method of improving at least one of a business process, product and service, may include accessing data relating to business objects of the at least one of a business process, product and service from a plurality of different databases; translating the accessed data; and correlating the translated data for subsequent use in improving the at least one of a business process, product and service.

Module A may preferably contain the elements an enterprise is dealing with (i.e. the business objects); module B indicates how to deal with the business objects (i.e. the business processes); and module C indicates what was, is and might be the state of your business (i.e. the business representation). Using these three modules, the business process and the whole business can be improved. Thus, a methodology for implementing this in conjunction with computer devices, will be discussed hereafter as an embodiment of the present invention.

FIG. 4 illustrates the three modules A-C used in the business improvement system. Any combination of the three modules may rest on one or a plurality of different IT applications 4. The processes of process house 2 are preferably described in a database which allows worldwide access to the standard process descriptions based on the business objects stored in a business object repository. The information house 10 may rest on a data warehouse 8, for example like the SAP business warehouse. To achieve consistency with the process house 2, the same business objects and the same database of business objects are used.

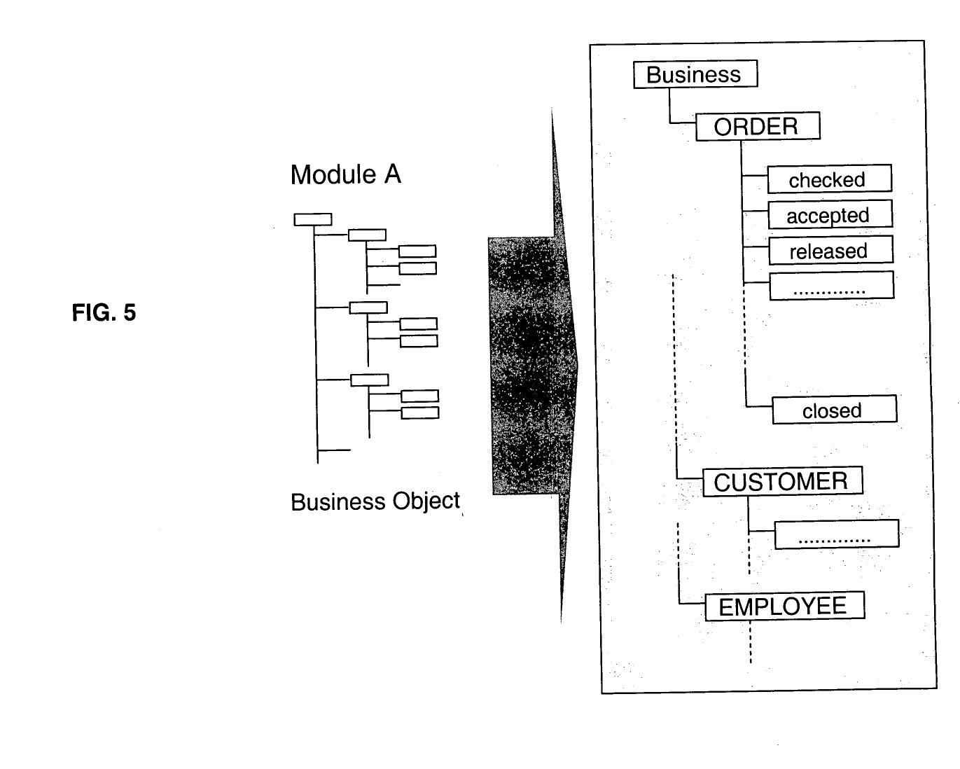

The business objects of module A may include at least a list of business relevant objects being processed and acting as input and output of the business processes. A more advanced aspect of the hierarchical structure of the business objects of module A, including composition and inheritance, is shown in exemplary format in FIG. 5. Shown here, in an exemplary format, are the objects ‘order’, ‘customer’ and ‘employee’, and relevant inputs and outputs of the business objects/processes (for example, for the object ‘order’, the specific aspects of ‘checked’, ‘accepted’ and ‘released’ are shown). At the end, the business objects may also encompass the attributes which describe the states of an object during the processes (not shown).

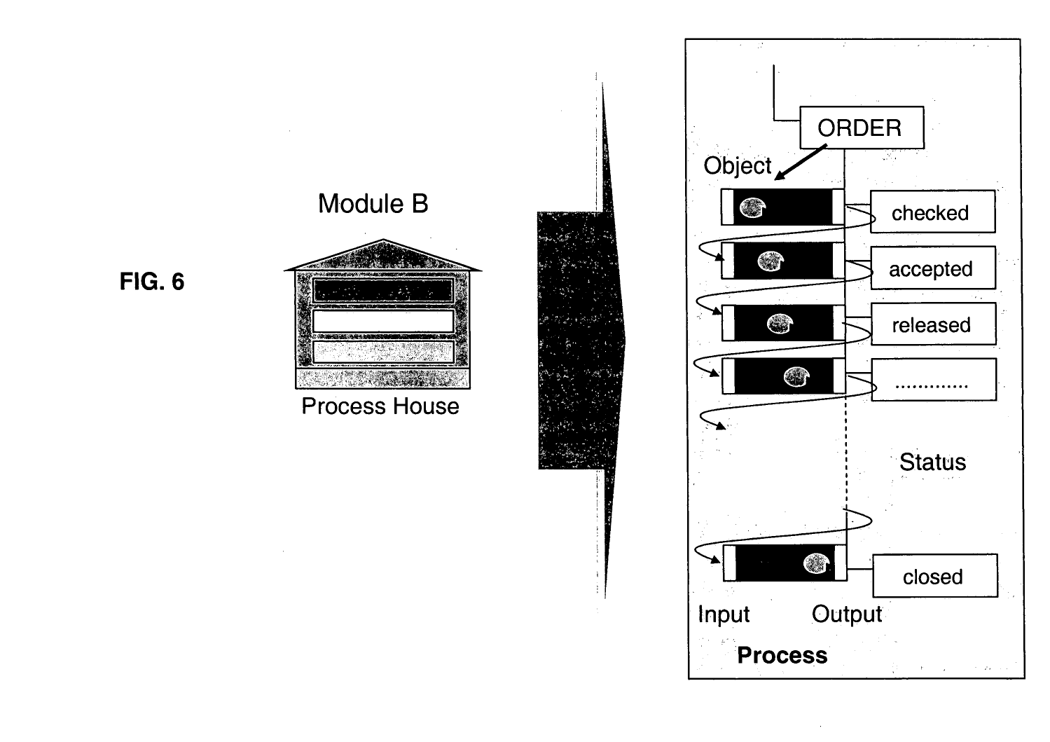

The business processes of module B may be separated into management, operating and support processes, for example. As shown in exemplary format in FIG. 6, the details of a process may follow a hierarchical principle from process, via process element, to detailed process element. As shown in exemplary format in FIG. 6, the input and outputs may be directly connected to the business objects defined in module A. An important additional feature of the processes may include the roles, which describe the owner of a process, which is the also responsible for the output; and the participants, which provide input and action.

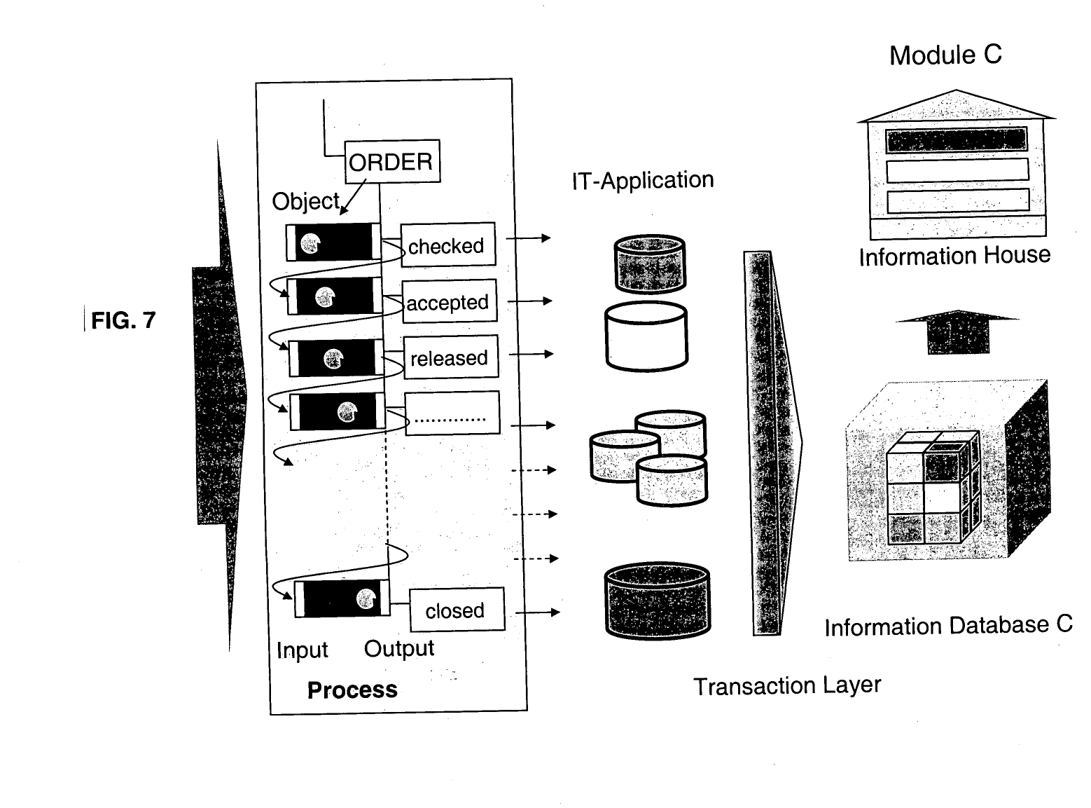

FIG. 7 is a continuation from FIG. 6, illustrating how the information from the process house 2 is used, in conjunction with transaction layer 6, to extract and store information from databases supported by potentially different IT applications, into an information database 8 as compatible information. This compatible information can then be used in information house 10.

The business representation of module C contain the results of the business processes. The results are based on the business objects which themselves are assigned to the processes. At least the business representation may be a collection of all input and output data of the business objects telling what's going on in a process related to a certain object like order. More advanced is an evaluation of the performance of a process which looks at all objects running through a process telling you e.g. how many objects passed the first time. The most advanced state is the comparisons and correlation of different processes and their performance and the usage of this information for business improvement.

The module A can be viewed as a container of the business objects. The module B can be viewed as a process house 2. Each may be implemented on a separate IT application. To achieve consistency between the process house 2 and the information house 10, the transaction layer 6 is used and both have to follow the business objects described and stored in business object repository.

In the process house 2, the management processes may be viewed as being in the attic rooms; the operating processes as being in the floors; the support processes being viewed as building the basement. A process house 2 may thus store at least one of management, operating and support processes for the at least one of the business process, product and service, wherein the accessed data relating to business objects may include results of at least one of the management, operating and support processes performed on the business objects.

Further, at least one report may be generated from the correlated data in the information house 10. For example data on customer satisfaction may be correlated with data on sales turnover or data on product quality or data on delivery performance in the supply chain or even data on employee satisfaction. The generated report may then be sent to the process house 2 (continuing the cycle in a next-generation) for use in improving the at least one of a business process, product and service. For example, the process house 2 may use the generated at least one report to improve upon the handling of at least one of the management, operating and support processes to thereby improve the at least one of a business process, product and service. Data on customer satisfaction and data on sales like market share may be used to improve on-time delivery of goods or to improve product quality by a redesign of the product.

As module C is viewed as a representation of output the business processes, it may be viewed as an information analogue to the process house 2. While the process house 2 may dictate how to act upon business objects, the information house 10 may dictate the output of the business processes that are related to the business objects. If the information is used in a smart and sophisticated way, a business can be improved.

The results of the improvement activities can then lead to a change of the business processes. Improved or even optimized business processes can then provide better performance based on the business objects. The performance can then represented in the information house 10. This information can then be used again and again for business improvement. Therefore the process house 2 and information house 10 can build major elements in a continuous improvement in not only the process, but also in the business cycle.

The activities described in the process house 2 are supported and accompanied by information technologies (IT) applications, which can be provided with overlapping and/or different databases containing the same information in different formats, names and forms. Normally many different so-called “best of breed” applications exist, which may use different databases for example, for different processes since every function in a business unit is attempt to improve processes associated therewith. Often, in an enterprise having similar businesses, each business unit uses different IT applications. Since the investment in IT and IT applications is rather expensive, it is not likely and is not cost effective to move all applications to one platform at one time.

On the other hand, it can be rather difficult to excerpt data out of the different applications to get information, such as information which may be useful or even necessary to determine performance of processes or even the entire business. Such information should ideally be available, in a reliably working format, to the information house 10. To solve the problem of different IT applications and the usefulness of information on business performance, an embodiment of the present application recognizes that additional elements need to be added in the whole improvement cycle. One such element, in one embodiment of the present application, can be the data warehouse 8. This can be the basis of the information house 10. Thus, data may be accessed from storage in a data warehouse 8, translated into compatible data and then stored prior to correlation in the information house 10, for example.

A second even more important element in one embodiment of the present application, is a transaction layer 6 between the data warehouse and the IT applications. Such a transaction layer 6 may act to translate the data as follows.

The transaction layer 6 can be an intelligent machine/device/tool full of business rules. These rules can indicate to the IT application, which of the data in the application is used and how it is transacted. This can be conveyed to the data warehouse 8. This transaction layer 6 may thus permit the efficient use of many different IT applications, as it would not make economic sense to move all the data of IT applications to the data warehouse 8 at the risk of inconsistency

On one hand, the business rules of the transaction layer 6 may be derived from the business objects and there attributes. On the other hand, the business rules may also define where data are stored. It can further define which entities in the organization are provided with access to sometimes very sensitive data, e.g. financial results or product roadmaps.

Thus, the complete business improvement cycle of one embodiment of the present application may include and/or involve:
the business objects and associated attributes,
a process house 2 to indicate how business objects should be handled,
IT applications 4 which support the processes in providing and collecting data,
a transaction layer 6 which converts the data from the IT application to data for the data warehouse, based on defined business rules, and
an information house 10 which provides information/results regarding the performance of the business and the information for and/or about improving the business.

The transaction layer 6 may transform or otherwise convert data from different IT applications, each of which support ones of the processes in the process house 2, into data for use in the data warehouse 8 such that the data of the data warehouse 8 are consistent data to represent the process house 2 as an information house 10 (which can be a mirror of all actions of a business). Thus, the transaction layer 6 may act to convert previously incompatible data of the IT applications 4 into compatible data which can be used and analyzed.

The transaction layer 6 works based on a set of rules, preferably originated and dictated by the process house 2. For example, the rules may indicate: Take the data of a business object out of the related IT application and put it into the data warehouse 8 according to the definition of the business object in the process house 2. By applying such rules, the data of the data warehouse 8 are directly linked to the process house 2. Therefore, an information house 10 may evolve out of the data in the data warehouse 8 being equivalent to the process house 2.

Regarding ‘business objects’ as used throughout the present application, the following information is provided. For example, ‘deliver’ may be one core process in a Supply Chain Management. The business object in ‘deliver’ may be ‘Order’. An ‘order’ may assume several states during processing in ‘deliver’. One state may be ‘order accepted’, another state may be ‘order paid’. ‘Order accepted’ and ‘order paid’ can then be the output of different process steps within the business object ‘deliver’.

There may be different functions in an organization or even different organizations which are responsible for the output ‘order accepted’ and ‘order paid’. These different functions or organizations may use different IT applications for historical or practical reasons (e.g. “Best of Breed”). Normally, different IT applications have different design and data formats.

In an IT application, information on a specific ‘order’ may be stored as data. These data can include, but are not limited to ‘order number’, ‘customer of the order’, ‘date of order accepted’, ‘date of order paid’, data on the acceptance of the order the first time, data on the kind of payment, full or partial, etc.

However, many data on an ‘order’ may be stored in different IT applications by different organizational units. For example, from customer surveys information may be known including but not limited to: observation of individual process steps, benchmarking results, lack of money that the process ‘deliver’ is of bad performance, etc. To change or improve the situation, an embodiment of the present application provides the ability to go into the individual IT applications and try to find out if the output of the process steps was achieved on time, in the right quality, etc.

Using a data warehouse 8 with consistent data directly linked to the defined processes, as provided through the transaction layer 6, it is much easier to immediately view the performance of the process steps, of the core processes like ‘deliver’ for example, of business processes like Supply Chain Management, of the whole process framework or process house 2, etc.

Copying all of the data from all IT applications supporting the process framework or process house 2, into a data warehouse 8, is not an acceptable option. Thus, the transaction layer 6 in one embodiment of the present application, uses rules to determine which kind of data have to be selected within each IT application. It can then transform these selected data from an existing data format, to a format consistent with data warehouse. Thus, the data can be linked together in such a way that e.g. the ‘cycle time’ from ‘order accepted’ until ‘order paid’ can be extracted. If the ‘cycle time’ of the object ‘order’ is placed into the information house 10, all the orders of the ‘deliver’ process can be visualized, analyzed and/or correlated according to different aspects. These can include for example, but are not limited to trend overtime, segmentation into different kinds of products, regions, locations or customers etc.

Today the process and the IT application are mostly closely linked to the function or organization. Therefore a set of standard processes, a process framework of most or even all business processes (called the process house 10), can be used according to an embodiment of the present application, which allows not only the improvement of one process in a function, but the overall business improvement regardless the organization. With the process house 2 as a structure, data can be analyzed, compared and/or correlated from, for example, customer relationship management, e.g. customer satisfaction or sales figures, with data from supply chain management, e.g. on-time delivery, with data from product lifecycle management, e.g. product reliability, with data from human resource management, e.g. employee satisfaction with training, etc. The correlated information may then be used to generate at least one report from the correlated data, for use in improving the at least one of a business process, product and service.

In one embodiment of the present application, the process house 2, with the process steps, the business objects and the defined states of the output, provides the basic rules for the transaction layer 6. In this way, a consistent set of data is obtained which is linked to the object in a process and the output of a process. This set of data can represent the performance of the single process and the performance of the whole business based on the process house 2. One non-limiting example is described as hereafter.

Imagine that business profit is much worse than the profit of your competitors. What are doing? What can be done?

One begins to look for consultants. For a short time, a higher profit may be obtained, but then the same problem is faced as before. Then, one looks for another consultant. Better results may again be obtained for a short time. However, repeating this approach several times probably confuses the organization more than it helps since each consultant has probably has its own program or model.

The real question to be asked is how can sustainable profitability be achieved. Two basic questions should be answered: HOW do we work and WHAT do we achieve? The answer of HOW can be the Process House; the answer of WHAT can be the Information House. When one can determine how one acts and when one can determine the performance of output, then one can initiate the proper business improvement actions. The system and method of a preferred embodiment of the present application makes this happen.

FIG. 5 shows, in exemplary format, how the business objects are structured using the business object ‘order’. The list of business objects can be a simple excel format, or a more sophisticated database containing all the synonyms of order used in a business and also information on the formats used in different IT applications. The structure of the business object provides the basis for the process description and the interfaces or intersections in the business processes, as shown in exemplary format in FIG. 6. Standard IT tools for process description like ARIS may be used. The order process is supported by different IT applications providing data on order planning, order entry, order tracking, order cost etc. like SAP supply chain tools as shown in exemplary format in FIG. 7. Data of the IT applications are transferred to an data warehouse like SAP business warehouse via the transaction layer. The transaction layer may be an intelligent computer network containing all the rules necessary to provide consistent data in the information house for reporting, analysis, control etc.

The process house 2 may include a set of all processes necessary to perform the acts of the business. The hierarchical structure of the processes described in the process house 2 allows a flexible implementation according to the business needs. On top level the process house 2 provides a common description for all business units while the details are described within a certain business unit. The standard processes are available by a common process description tool and by web publishers. In this way, everybody involved in the processes gets an access to the standard and detailed descriptions.

As one non-limiting example of the system and/or process of one embodiment of the present application, the business processes including supply chain management for example, may be divided into core processes like source, make, deliver and plan for example. A deliver process with the business object ‘order’ may contain process steps like ‘accept order’ or ‘pay order’ for example, resulting in outputs like ‘order accepted’ and ‘order paid’, for example. The data on the business object ‘order’ may be stored in IT applications. For planning, another software tool may be used than that for order processing, and again a different software tool may be used for order tracking. This ‘real’ world may be large and complex with millions of different data.

The transaction layer 6, for example being stored in a computer in form a multi-dimensional matrix, may then include a set of rules based on the process house 10 which extracts data out of the different software applications according to the business objects and outputs defined in the process house 2. It then may transform the data into a compatible format based on other rules and store transformed and chosen or selected data into the data warehouse 8. For example, the data time of ‘order accepted’ and time of ‘order paid’ may be extracted, transformed and sent to the data ware house. If the two times are then combined, a cycle time from ‘order’ accepted to ‘order paid’ can be determined.

By choosing the orders for a certain time interval, information on the trend of the cycle time may be obtained and segmented for different kind of orders or different order processing units in the information house 10. Since the information house 10 provides the performance of most or even all processes selected via the transaction layer 6, the cycle time of the deliver process can then be correlated with the customer satisfaction on delivery of goods out of the process ‘Analyze Customer’ in the business process ‘Customer Relationship Management’, for example. In the case of a deep analysis being necessary, the transaction layer 6 can be used to drill down into the original data of an order, that which happened in a certain process step, described in the process house 2, can be viewed.

The analysis of the information provided via the information house 10 then can lead to the business improvement usable to achieve the a desired profit and/or business performance, for example. As such, method/system of improving at least one of a business process, product and service may be derived. Such a method, for example, can thus generally include accessing data relating to business objects of the at least one of a business process, product and service from a plurality of different databases. Thereafter, the accessed data may be translated and correlating for subsequent use in improving the at least one of a business process, product and service.

The above-mentioned embodiment of a method/system of the present application may be applied to other entities, other than a business as well. One non-limiting exemplary aspect of an application to a hospital or any other institution, for example, will be described hereafter.

When somebody has to go into a hospital, the first step is normally admission. Next is normally the diagnosis, some kind of treatment, and at the end the release. This is often followed by some kind of post-clinical cure or rehabilitation.

Besides this patient centred main clinical core process, a development process for new operation and curing methods may be developed. Additionally the hospital often cares for relatives of a patient and often cares for the patient after the clinical stay when in a healthy state, offering regular preventive examinations and check ups for example. The management of the hospital plans the necessary resources, competences, budget, etc; and attempts to control the cost and other process and patient related performance figures. The patient centred processes are supported by a series of processes like examination in laboratory, provision of medicines, catering etc.

Similar to that of other enterprises, a hospital may act as an enterprise as well. A hospital defines its business objects, wherein the most important is the patient. The patient obtains certain states when passing the typical clinical processes of diagnosis, treatment and cure, for example. This processes is analogous to the supply chain management in a industrial company.

Caring of a patient before and after a clinical stay, and caring of relatives of a patient, are similar to customer relationship management, which is one of the main operating processes of an enterprise. Developing new surgery methods for the heart or knee, for example, may provide a competitive advantage in a hospital market. For example, it is good publicity for the hospital if treatment is with less pain and less process cost and/or if treatment is shorter than before. This process is similar to the product lifecycle process in an industrial environment.

Further, a hospital uses and desires some kind of strategic planning and controlling. It also uses support processes like human resource management, financial management, accounting, quality management, information management etc. Thus, to summarize, a hospital can use also a process house based on business objects. Information on a patient can thus be collected and stored. More and more IT applications are used for this purpose. Therefore, an information house linked to the process house (through a transaction layer, for example) can also be used. In the end, a patient centered hospital can continuously improve its health business, not only for better patient treatment, but also for higher satisfaction of relatives and employees for example. In addition, a patient centered hospital can continuously improve by increasing its profitability.

The above-described embodiments of the present invention may be based on combining individual models, modules, and methods for describing a process and supporting the process with IT applications and data warehouses in an enhanced or even optimum new type of methodology.

As to structure of the system, a uniform system may be created, as can a universally usable new process and information model. In one embodiment, the system can include a device for accessing data relating to the at least one of a business process, product and service from a plurality of different databases, wherein the data are accessed from databases supported by a plurality of different IT applications; a device for translating the accessed data into compatible data; and a device for correlating the translated compatible data, wherein the correlations are used to improve the at least one of a business process, product and service.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of improving at least one of a business process, product and service, comprising:
accessing data relating to business objects of the at least one of a business process, product and service from a plurality of different databases;
translating the accessed data; and
correlating the translated data for subsequent use in improving the at least one of a business process, product and service.

2. The method of claim 1, wherein the translating is achieved in a transaction layer, including rules for translating the data, obtained from different databases, into compatible data for correlation.

3. The method of claim 1, wherein at least a portion of the data stored in at least one database is incompatible with at least a portion of the data stored in at least one other database, and wherein the translating includes translating at least a portion of the data stored in each of the at least one and at least one other database into data compatible for correlation.

4. The method of claim 1, wherein at least some of the plurality of different databases are supported by different IT applications, wherein at least some of the data stored in databases supported by different IT applications are incompatible with each other.

5. The method of claim 4, wherein the translating includes rules for translating the data obtained from different databases, including at least some incompatible data of different databases supported by different IT applications, into compatible data for correlation.

6. The method of claim 1, wherein the data are accessed, translated into compatible data and then stored prior to correlation.

7. The method of claim 6, wherein the data are stored in a data warehouse, and then correlated in an information house.

8. The method of claim 1, further comprising:
generating at least one report from the correlated data, for use in improving the at least one of a business process, product and service.

9. The method of claim 1, further comprising:
generating at least one report from the correlated data, and sending the generated report to a process house for use in improving the at least one of a business process, product and service.

10. The method of claim 9, wherein the process house uses the generated at least one report to improve upon the handling of the business objects and thereby improve the at least one of a business process, product and service.

11. The method of claim 9, wherein the process house stores at least one of management, operating and support processes for the at least one of a business process, product and service, and uses the generated at least one report to improve upon the handling of at least one of the management, operating and support processes to thereby improve the at least one of the business process, product and service.

12. The method of claim 1, wherein a process house stores at least one of management, operating and support processes for the at least one of the business process, product and service, and wherein the accessed data relating to business objects includes results of at least one of the management, operating and support processes performed on the business objects.

13. The method of claim 12, further comprising:
generating at least one report from the correlated data, and sending the generated report to the process house for use in improving the at least one of a business process, product and service.

14. A method of improving at least one of a business process, product and service, comprising:
accessing data relating to the at least one of a business process, product and service from a plurality of different databases, wherein the data are accessed from databases supported by a plurality of different IT applications;
translating the accessed data into compatible data; and
correlating the translated compatible data, wherein the correlations are used to improve the at least one of a business process, product and service.

15. The method of claim 14, wherein the data are accessed, translated into compatible data and then stored prior to correlation.

16. The method of claim 14, further comprising storing data supported by a plurality of different IT applications in a data warehouse prior to translating.

17. The method of claim 16, wherein the translating and correlating are performed in an information house using a transaction layer.

18. The method of claim 17, further comprising:
generating at least one report from the correlated data, and sending the generated report to at least one of a process, product and service house for use in improving the at least one of a business process, product and service.

19. The method of claim 14, wherein the accessed data includes business objects of the at least one of a business process, product and service.

20. The method of claim 19, further comprising:
generating at least one report from the correlated data, and sending the generated report to at least one of a process, product and service house for use in improving the business objects of the at least one of a process, product and service.

21. The method of claim 14, wherein the translating is achieved in a transaction layer including rules for translating the data, obtained from different databases, into compatible data for correlation.

22. The method of claim 14, wherein the translating includes rules for translating the data, obtained from different databases, into compatible data for correlation.

23. The method of claim 14, wherein at least some of the data stored in databases supported by different IT applications are incompatible with each other.

24. The method of claim 14, wherein the translating includes rules for translating the data obtained from different databases, including at least some of different databases supported by different IT applications, into compatible data for correlation.

25. The method of claim 23, wherein the translating includes rules for translating the data obtained from different databases, including at least some incompatible data of different databases supported by different IT applications, into compatible data for correlation.

26. The method of claim 14, wherein the data are stored in a data warehouse, and then correlated in an information house.

27. The method of claim 14, further comprising:
generating at least one report from the correlated data, and sending the generated report to a process house for use in improving the at least one of a business process, product and service.

28. The method of claim 27, wherein the process house uses the generated at least one report to improve upon the handling of business objects relating to the at least one of a business process, product and service and thereby improve the at least one of a business process, product and service.

29. The method of claim 27, wherein the process house stores at least one of management, operating and support processes for the at least one of a business process, product and service, and uses the generated at least one report to improve upon the handling of at least one of the management, operating and support processes to thereby improve the at least one of the business process, product and service.

30. The method of claim 14, wherein a process house stores at least one of management, operating and support processes for the at least one of the business process, product and service, and wherein the accessed data relates to business objects of the at least one of a business process, product and service, and includes results of at least one of the management, operating and support processes performed on the business objects.

31. The method of claim 30, further comprising:
generating at least one report from the correlated data, and sending the generated report to the process house for use in improving the at least one of a business process, product and service.

32. The method of claim 31, wherein the process house uses the generated at least one report to improve upon the handling of at least one of the management, operating and support processes to thereby improve the at least one of a business process, product and service.

33. A system for implementing the method of claim 1.

34. A program, adapted to perform the method of claim 1, when executed on a computer device.

35. A computer readable medium, storing the program of claim 34.

36. A system for implementing the method of claim 14.

37. A program, adapted to perform the method of claim 14, when executed on a computer device.

38. A computer readable medium, storing the program of claim 37.

39. A system for improving at least one of a business process, product and service, comprising:
means for accessing data relating to the at least one of a business process, product and service from a plurality of different databases, wherein the data are accessed from databases supported by a plurality of different IT applications;
means for translating the accessed data into compatible data; and
means for correlating the translated compatible data, wherein the correlations are used to improve the at least one of a business process, product and service.

40. The system of claim 39, further comprising:
means for storing data supported by a plurality of different IT applications prior to translating.

41. The system of claim 39, further comprising:
means for generating at least one report from the correlated data, and for sending the generated report to at least one of a process, product and service house for use in improving the at least one of a business process, product and service.

42. The system of claim 39, wherein the accessed data includes business objects of the at least one of a business process, product and service.

43. The system of claim 42, further comprising:
means for generating at least one report from the correlated data, and sending the generated report to at least one of a process, product and service house for use in improving the business objects of the at least one of a process, product and service.

44. The system of claim 39, wherein at least some of the data stored in databases supported by different IT applications are incompatible with each other.

45. The system of claim 39, wherein the translating includes rules for translating the data obtained from different databases, including at least some of different databases supported by different IT applications, into compatible data for correlation.

46. The system of claim 44, wherein the translating includes rules for translating the data obtained from different databases, including at least some incompatible data of different databases supported by different IT applications, into compatible data for correlation.

47. A system for improving at least one of a business process, product and service, comprising:
at least one of a process, product and service house, adapted to store data in data bases relating to objects of a business, wherein the data are stored in databases supported by a plurality of different IT applications;
a transaction layer, adapted to access data relating to the at least one of a business process, product and service from a plurality of different databases, and adapted to translate the accessed data into compatible data; and
an information house, adapted to correlate the translated compatible data, wherein the correlations are used to improve the at least one of a business process, product and service.

48. The system of claim 47, further comprising:
a data warehouse, adapted to store data supported by a plurality of different IT applications prior to translating.

49. The system of claim 47, wherein at least one report is adapted to be generated from the correlated data, the generated report then adapted to be sent to the at least one of a process, product and service house for use in improving the at least one of a business process, product and service.

50. The system of claim 47, wherein the accessed data includes business objects of the at least one of a business process, product and service.

51. The system of claim 50, wherein at least one report is adapted to be generated from the correlated data, the generated report then adapted to be sent to the at least one of a process, product and service house for use in improving the at least one of a business process, product and service.

52. The system of claim 47, wherein at least some of the data stored in databases supported by different IT applications are incompatible with each other.

53. The system of claim 47, wherein the translating includes rules for translating the data obtained from different databases, including at least some of different databases supported by different IT applications, into compatible data for correlation.

54. The system of claim 52, wherein the translating includes rules for translating the data obtained from different databases, including at least some incompatible data of different databases supported by different IT applications, into compatible data for correlation.

55. A system for improving at least one of a business process, product and service, comprising:
means for storing data in data bases relating to objects of a business, wherein the data are stored in databases supported by a plurality of different IT applications;
means for accessing data relating to the at least one of a business process, product and service from a plurality of different databases, and adapted to translate the accessed data into compatible data; and
means for correlating the translated compatible data, wherein the correlations are used to improve the at least one of a business process, product and service.

56. The system of claim 55, further comprising:
means for storing data supported by a plurality of different IT applications prior to translating.

57. The system of claim 55, further comprising:
means for generating at least one report from the correlated data, and for sending the generated report to at least one of a process, product and service house for use in improving the at least one of a business process, product and service.

58. The system of claim 55, wherein the accessed data includes business objects of the at least one of a business process, product and service.

59. The system of claim 58, further comprising:
means for generating at least one report from the correlated data, and sending the generated report to at least one of a process, product and service house for use in improving the business objects of the at least one of a process, product and service.

60. The system of claim 55, wherein at least some of the data stored in databases supported by different IT applications are incompatible with each other.

61. The system of claim 55, wherein the translating includes rules for translating the data obtained from different databases, including at least some of different databases supported by different IT applications, into compatible data for correlation.

62. The system of claim 60, wherein the translating includes rules for translating the data obtained from different databases, including at least some incompatible data of different databases supported by different IT applications, into compatible data for correlation.
